(19) United States
(12) Patent Application Publication
(10) Pub. No.: US 2002/0122861 A1
(43) Pub. Date: Sep. 5, 2002

(54) Non-alcoholic beverage incorporating ginger and margarita mix having the taste of alcohol

(76) Inventor: William Tocantins, Los Angeles, CA (US)

Correspondence Address: CISLO & THOMAS, LLP, 233 WILSHIRE BLVD, SUITE 900, SANTA MONICA, CA, 90401-1211, US

(21) Appl. No.: 09/800,058

(22) Filed: Mar. 5, 2001

(51) Int. Cl. A23L 1/236

(52) U.S. Cl. 426/548

(57) ABSTRACT

A beverage comprising ginger root juice, a sweetener, citrus juice and water, heated to a temperature and for a time for pasteurization to occur, whereby an improved, healthier and tastier margarita mix is formed offering the sensation of alcohol.

### BACKGROUND OF THE INVENTION

1. Field of the Invention

This invention relates generally to non-alcohol cocktail mixes and more specifically to non-alcoholic cocktail mixes that incorporate a ginger and margarita mix that result in a tastier, healthier beverage offering the sensation of alcohol.

2. Description of the Related Art

Margarita mixes are well known in the art. The margarita originated in the desert town of Tequila, Mexico, which is the only place that the Blue Agave plant is grown. The plant is used to make a local distilled spirit commonly called Tequila. Several other ingredients indigenous to the region, primarily lime juice but also lemon-lime juice, and a sweetener, are mixed together to form a consumable liquid that can be combined with an alcoholic beverage, namely Tequila.

Many versions of the lemon-lime sweetener mix have been developed. Some are made with natural ingredients while others are made with chemicals designed to imitate the lemon-lime sweetener flavor. While a variety of methods exist, including liquid ingredients, frozen ingredients and dry powders, almost all are made to resemble the lemon-lime sweetener flavor in a beverage mix commonly known as Margarita Mix.

Ginger is derived from the tuberous rhizome (underground root) of the perennial plant Zingiber officinale of the family Zingiberaceae. Ginger root is a time-proven remedy for upset stomach, indigestion, cramps and to dispel chills and has been used as a medicine since ancient times. The approved modem therapeutic applications for ginger root juice are supportable based on its history of use in well established systems of traditional and conventional medicine. Although ginger root juice is almost always used in foods, it is rarely used in beverages.

What is needed in the art is an all natural non-alcoholic beverage that has a long shelf life, which contains ginger root juice and margarita mix ingredients, that can be mixed with alcohol, another alcoholic beverage or consumed on its own to provide a healthier, tastier beverage that has a ginger flavor and can be used as a margarita mix. Also, what is needed is a beverage that tastes as if it contains alcohol, but does not.

### SUMMARY OF THE INVENTION

The present invention creates a healthier, tastier beverage that can be consumed on its own or mixed with alcohol and other alcoholic beverages. If used without alcohol, it can still offer the taste or sensation of alcohol. The beverage comprises ginger root juice, sugar, citrus juice and water, which is heated and bottled in a sterile environment.

### OBJECTS OF THE INVENTION

It is an object of the present invention to provide a beverage, which can be consumed independently or mixed with alcohol or alcoholic beverages, that provides unique health benefits and provides a sensation to the palate of alcohol.

These and other objects and advantages of the present invention will be apparent from a review of the following specification.

### DESCRIPTION OF THE PREFERRED EMBODIMENT(S)

The detailed description set forth below is intended as a description of presently-preferred embodiments of the invention and is not intended to represent the only forms in which the present invention may be constructed and/or utilized. The description sets forth the functions and the sequence of steps for constructing and operating the invention. However, it is to be understood that the same or equivalent functions and sequences may be accomplished by different embodiments that are also intended to be encompassed within the spirit and scope of the invention.

The present invention provides a healthier, tastier non-alcoholic beverage that primarily has a ginger flavor. This beverage can be consumed as a mixture with alcohol such as tequila for margaritas or other alcohols or alcoholic beverages. It can also be consumed independently from other alcoholic or non-alcoholic liquids.

In the preferred embodiment, three fluid ounces of ginger juice is used for a quart of the present invention. However, between one and five fluid ounces of ginger juice can be used depending upon the taste preference of the individual user or group for the present invention. The ginger root juice is extracted from the ginger root by grinding fresh ginger root and retaining the oils or ginger root juice found under the skin of the ginger root. These oils used in the present invention are normally discarded in most other uses of ginger root. Ginger has been known in the art to aid people that suffer from arthritis and rheumatic disorders, aid in digestion, prevent gastrointestinal ulcers, decrease both blood and heptic cholesterol among other benefits.

Next, a citrus juice is added to the ginger juice. Lemon juice, lime juice or a combination thereof can be used for the beverage. The preferred embodiment uses four fluid ounces of lemon juice. However, at least one fluid ounce of citrus juice should be used in the present invention. This amount may vary for taste preference, but not as to change from the primary flavor of ginger. After the citrus juice, a sweetener is added. In the preferred embodiment, six ounces by weight of refined cane sugar is used. However, in other embodiments at least one ounce of sweetener(dry) should be used. Also, an alternate sweetener in the form of corn syrup, high fructose corn syrup may be used to produce results similar to those achieved with the refined cane sugar. In the preferred embodiment, all of the ingredients are all natural, however a synthetic or artificial sweetener such as aspartame or nutrisweet may be used in other embodiments.

Mixing all of these items with water, three cups in the preferred embodiment, form a combination of ingredients. In other embodiments, at least one cup of water should be used. This combination of ingredients is heated at a temperature and for a period of time to achieve pasteurization. In the preferred embodiment, the combination of ingredients is heated to a temperature of at least 185 degrees Fahrenheit for at least 5 minutes. Once pasteurization occurs, the pasteurized combination of ingredients is poured into sterile bottles. With this process, the present invention maintains a long shelf life without the need for preservatives. Although pasteurization is used with the present invention, other methods can be used to reduce the bacteria and provide the beverage with a longer shelf life.

In the present invention, the many health benefits, in conjunction with the fact that the beverage provides a sensation to the palate of alcohol while being a non-alcoholic beverage, adds to the utility of this unique beverage. For this reason, the present invention may be used as an aid in the control of or recovery from alcohol addictions.

The present invention can also be marketed as a beverage syrup, used for reproduction at a service establishment or the like. The preferred combination of ingredients for the syrup is ten fluid ounces of ginger root juice, twelve fluid ounces of citrus juice and three cups of sweetener. Lemon juice, lime juice or a combination thereof can be used for the citrus juice. Sweetener in the form of refined cane sugar, corn syrup, high fructose corn syrup may be used, however a synthetic or artificial sweetener such as aspartame or nutrisweet may be used in other embodiments. The syrup is produced by the same process as the prior embodiments of the present invention. The ginger root juice, the citrus juice and the sweetener are mixed to form a combination of ingredients that is then heated to a temperature and for a time sufficient to achieve pasteurization and then poured into sterile bottles. Normally for pasteurization to occur, the combination of ingredients is heated to a temperature of at least 185 degrees for at least 5 minutes. The service establishment would use one ounce of this syrup in combination with their current additives for their margarita mix to produce the beverage incorporating ginger and margarita mix.

While the present invention has been described with regards to particular embodiments, it is recognized that additional variations of the present invention may be devised without departing from the inventive concept.

What is claimed is:

1. A beverage comprising:
ginger root juice,
a sweetener,
citrus juice,
and water,
wherein said beverage provides unique health benefits and provides a sensation to the palate of alcohol while being a non-alcoholic beverage.

2. A beverage as set forth in claim 1, wherein
at least one cup of said water, at least one fluid ounce of said ginger root juice, at least one fluid ounce of said citrus juice and at least one ounce of said sweetener form a combination of ingredients.

3. A beverage as set forth in claim 2, wherein,
said citrus juice is lemon juice, lime juice or combinations thereof.

4. A beverage as set forth in claim 3, wherein
said sweetener is chosen from a group consisting of refined cane sugar, corn syrup, high fructose corn syrup, and synthetic sweeteners.

5. A beverage as set forth in claim 4, wherein
said synthetic sweeteners are selected from aspartame and nutrisweet.

6. A beverage as set forth in claim 5, wherein
three fluid ounces of said ginger root juice,
four fluid ounces of said citrus juice,
six ounces by weight of said sweetener and
three cups of water form said combination of ingredients.

7. A beverage incorporating ginger, said beverage being produced by the process comprising:
a) grinding fresh ginger root and extracting the oils or ginger root juice,
b) adding sweetener, citrus juice and water, forming a combination of ingredients,
c) heating said combination of ingredients to a temperature and for a time sufficient to pasteurize said combination of ingredients, and
d) pouring said pasteurized combination of ingredients into a sterile container,
wherein said beverage provides unique health benefits and provides a sensation to the palate of alcohol while being a non-alcoholic beverage.

8. A beverage as set forth in claim 7, wherein
at least one fluid ounce of said ginger root juice,
at least one fluid ounce of said citrus juice,
at least one ounce of said sweetener and
at least one cup of water forms said combination of ingredients

9. A beverage as set forth in claim 8, wherein
said citrus juice is lemon juice, lime juice or combinations thereof.

10. A beverage as set forth in claim 9, wherein
said sweetener is chosen from a group consisting of refined cane sugar, corn syrup, high fructose corn syrup, and synthetic sweeteners.

11. A beverage as set forth in claim 10, wherein
said synthetic sweeteners are selected from aspartame and nutrisweet.

12. A beverage as set forth in claim 11, wherein
said combination of ingredients are heated to a temperature of at least 185 degrees for at least 5 minutes.

13. A beverage and method of making the same comprising,
ginger root juice,
a sweetener,
citrus juice,
water,
at least one cup of said water, at least one fluid ounce of said ginger root juice, at least four fluid ounces of said citrus juice and at least six ounces of said sweetener form a combination of ingredients,
said citrus juice is lemon juice, lime juice or combinations thereof,
said sweetener is chosen from a group consisting of refined cane sugar, corn syrup, high fructose corn syrup and synthetic sweeteners,
said synthetic sweeteners are selected from a group consisting of aspartame and nutrisweet,
heating said combination of ingredients to a temperature and for a time sufficient to pasteurize said combination of ingredients,
pouring said pasteurized combination of ingredients into a sterile container;
wherein said beverage provides unique health benefits and provides a sensation to the palate of alcohol while being a non-alcoholic beverage.

14. A beverage and method of making the same comprising,
ginger root juice,
a sweetener,
citrus juice,
water,
three cups of said water, three fluid ounces of said ginger root juice, four fluid ounces of said citrus juice and six ounces of said sweetener form a combination of ingredients,
said citrus juice is lemon juice, lime juice or combinations thereof,
said sweetener is chosen from a group consisting of refined cane sugar, corn syrup, high fructose corn syrup and synthetic sweeteners,
said synthetic sweeteners are selected from a group consisting of aspartame and nutrisweet,
heating said combination of ingredients to a temperature and for a time sufficient to pasteurize said combination of ingredients,
pouring said pasteurized combination of ingredients into a sterile container,
wherein said beverage provides unique health benefits and provides a sensation to the palate of alcohol while being a non-alcoholic beverage.

15. A beverage and method of making the same comprising,
ginger root juice,
citrus juice and
a sweetener form a combination of ingredients,
heating said combination of ingredients to a temperature and for a time sufficient to pasteurize said combination of ingredients,
pouring said pasteurized combination of ingredients into a sterile container;
whereby a syrup is formed allowing a service establishment to combine one ounce of said syrup, which provides unique health benefits and provides a sensation to the palate of alcohol while being a non-alcoholic beverage, to their margarita mixture to produce said beverage.

16. A beverage and method of making the same as ser forth in claim 15, wherein
ten fluid ounces of said ginger root juice, twelve fluid ounces of said citrus juice and three cups of said sweetener form said combination of ingredients,
said citrus juice is lemon juice, lime juice or combinations thereof,
said sweetener is chosen from a group consisting of refined cane sugar, corn syrup, high fructose corn syrup and synthetic sweeteners,
said synthetic sweeteners are selected from a group consisting of aspartame and nutrisweet.

17. A beverage and method of making the same as set forth in claim 16, wherein
said combination of ingredients are heated to a temperature of at least 185 degrees for at least 5 minutes.
